(19) United States
(12) Patent Application Publication
(10) Pub. No.: US 2007/0174163 A1
(43) Pub. Date: Jul. 26, 2007

(54) Money management on-line courses

(76) Inventor: Katherine A. Griffin, Rockville, MD (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/338,890

(22) Filed: Jan. 25, 2006

(51) Int. Cl. G06Q 40/00

(52) U.S. Cl. 705/35

(57) ABSTRACT

An on-line interactive course is directed to teens and college students and uses anecdotal, situational and questioning approaches with interactive slides.

### CROSS REFERENCE TO RELATED APPLICATION

This application claims priority from U.S. Provisional Patent Application Ser. No. 60/551,234, entitled “Money Management On-Line Courses” and filed Feb. 10, 2005. The disclosure of that patent application is incorporated herein by reference in its entirety.

### BACKGROUND OF THE INVENTION

1. Technical Field

The present invention pertains to money management courses and, more particularly, to on-line money management courses primarily directed to teenagers and young adults.

2. Discussion of the Prior Art

The Problem: Financial illiteracy is an acute national problem, particularly among teens and young adults. Only 26% of 13 to 21-year olds reported their parents actively taught them how to manage money. Schools are not teaching teens financial decision-making skills, and parents don't know how to do this.

The Need: Financial training and tools must be provided for teens and young adults. Teens are at the ideal age to learn about finance. They are just beginning to manage money on their own, and generally have the skills to understand basic finance terms, computations, and graphical representations. The teenage years are the perfect time to learn that financial self-sufficiency requires planning and management. It has been shown that as little as 10 hours of personal financial education positively affects students' spending and savings habits.

Books are not the information source-of-choice for teens; this is an Internet generation. According to a study by AOL, 58% of teens ages 12-17 consult online resources homework help; 61% of teens ages 18-19 use the Internet for homework help and to access news, and 56% prefer Internet communication with friends/relatives rather than by phone.

There is a critical need for clear and accessible financial management training for teens and their parents. Parents want their teens to become money-savvy during their transition to adulthood, but finance is a complicated subject for parents to teach. Teens want to become independent, but our materialistic society sends unhelpful messages.

Financial concepts, which can be dry in text, are vividly and compellingly presented, in interactive exercises and simulations. Learning objectives are met in a compressed curriculum that is fun, engaging, and immediately practical.

### SUMMARY OF THE INVENTION

The present invention is a computer-based, dynamically-delivered asynchronous, multimedia course, teaching financial fundamentals, presented in the context of pre-college, college, and post-college life. Subsequent iterations of the present invention would serve broader audiences, including non-college-bound teens and adults. Content focuses on practical and powerful financial concepts, tools, and techniques that are immediately relevant and useful to young adults. The present invention shows what other courses only tell, in Units about: minimizing debt, creating an effective budget, managing bank accounts, and saving money for important future goals. The web is the resource of choice for this age group. The course is designed in a format that young adults expect: relevant, practical content presented in rich, engaging multimedia, including
Clear and compressed topic presentations
Interactive, learner-paced content includes dynamic video, worksheets, games, simulations, and learning assessments
Downloadable tools (spreadsheets, budget, contract) accompany the student throughout college and the years beyond
Rich and varied resources include downloadable .pdf articles, substantial source citations, links to relevant and objective websites, statistics, expert quotes, and glossary
Humor and real-world scenarios communicate with teens on their level
Offline assignments wherein the parent or adult mentor participates to reinforce and support learning objectives

The present invention is not merely information on a website, but high-caliber instructional design comprising
Learner-centered topic exploration
Multi-modal (e.g., visual, auditory, kinesthetic) concept presentation
Interactive skills practice
Iterative assessments in each Topic of each Unit
Designed for in-home and in-school use, including alternative settings such as community organizations
SCORM-compliant, and meets most Jumpstart™ Financial Literacy standards
Learning Management System compatible
   In less than 10 hours of “seat time”, students can:
Establish a system of accounts maintained by the student and accessible by the parent
Understand consequences and implications of debt; minimize debt burden at graduation
Create a spending plan (budget) to address the costs of college attendance
Use credit responsibly and avoid or minimize credit card debt
Understand the benefits and implications of savings, through and beyond college
Manage finances with increasing self-sufficiency, reinforced by reports and parent-student contract
Explore the financial tradeoff and viability of graduate school in their chosen field
Create a pro form a projection as a new wage-earner, for starting salary and expenses. Parent/mentors support and reinforce the student's new skills by
Balance responsibility, control, and intervention in money management during the student's semi-independent years
Learn the most common and disastrous mistakes parents make about college financing
Practice real-world “homework” applying skills and tools in fun, interesting assignments
Negotiate a contract covering finances, responsibilities, expectations and goals, gradually shifting financial responsibility from parent to student, toward self-sufficiency by graduation.

### BRIEF DESCRIPTION OF THE DRAWINGS

FIG. 1 is a bar chart depicting an illustration of an overall debt.

FIG. 2 is a bar chart depicting an illustration of cumulative annual debts.

FIG. 3 is a bar chart depicting an illustration of the time required to pay off a debt.

FIG. 4 is a bar chart depicting an illustration of an overall debt showing time to payoff.

FIG. 5 is a bar chart depicting an illustration individual debts showing total amount to be paid.

FIG. 6 is a pie chart illustrating total principal and interest for the term of a payment plan.

FIG. 7 is a chart displaying cumulative information depicted in FIGS. 1-7.

### DESCRIPTION OF THE PREFERRED EMBODIMENTS

Exemplary Course Content The following is a description of exemplary course content for which outlines, materials questions and answers are presented on-line for students.

### Credit & Debt 101

College Loans

Higher education is an investment in the future; it can mean more opportunities, better jobs, and higher salaries. Americans with a bachelor's degree earn an average of over 60% more than those with only a high school diploma. Comparing their lifetime earning potential, the college graduate typically brings in an extra $1,000,000. But like anything worth getting, higher education comes with a price—time, effort, and money. While in college, students invest their time and effort into earning that coveted diploma. All too often, college students and their families don't have the financial resources to fund an education, and there are not enough scholarships/grants to go around. Rather than forego college, many students adopt a philosophy of “Buy now, pay later.” College loans make this possible.

In this segment, following questions are answered:
What is a college loan?
What are the other types of financial aid?
How many college students fund education with loans, and what is the average loan debt?
What should you consider before deciding to get a loan?
What are the types of loans?
What should you look for when selecting the right college loan for you?
How do you apply for federal aid including loans?
How should you budget your college loan money?
What are some problems faced in paying back student loans and what are the options?
What are the consequences of defaulting on a loan?
Are their any rewards for paying back a loan on time?
After graduating, is it better to pay off a college loan early or invest extra income?
   What is a college loan?

A loan is simply something borrowed, such as money, that usually requires its return within a specified timeframe and with interest. It makes sense then that a college loan is money borrowed for the purpose of putting an individual through school.

College loans are a form of financial aid. While the amount of aid being awarded to students is on the rise, unfortunately, much of it requires repayment. The amount of aid available almost doubled from 1991 to 2001, but two-thirds of that increase comes in the form of loans, and tuition costs have increased significantly as well. Today, college loans make up more than half of the total aid awarded annually, and most students will receive a loan as part of their financial aid package.

What are the other types of financial aid?

Let's briefly look at other types of aid that might be included in a financial aid package.

Scholarships:

It's one thing to receive money that has to be repaid and quite another to get “free money”—money that never has to be repaid. Scholarships fall under the category of “free money.” There is a wide variety of scholarships available, and they are usually awarded based on merit. Students might be awarded scholarships based on their outstanding grades and test scores. There are scholarships for those who excel in sports or the arts and for those who win beauty pageants. There are scholarships for students who exhibit a financial need and those who come from a minority group. “Free money” may be given to promising students planning for a career in a particular field or for students who just meet a particular profile set by the sponsor of the scholarship.

Scholarships come from a variety sources such as companies, civic groups, charitable organizations, and private donors. Universities also offer a variety of scholarships. Donors to the university may give money to the school and earmark it for scholarships for a particular type of student. For instance, someone may donate $5,000 annually to a school so that a scholarship can be given to the African-American female student who is studying pre-med, entering her senior year, and holding the highest GPA.

Grants:

Another type of “free money” is grants. Their sources include federal and state governments as well as individual colleges. Government-sponsored grants like the Pell Grant and federal Supplemental Educational Opportunity Grants are typically awarded based on need. On the other hand, school-sponsored grants are often awarded based on a combination of both need and merit. Some grants are merit-based while a number are need-based. Almost half of students receive some grant money. For the 2002-2003 school year, eligible full-time students received an average of $9,100 in aid; $3,600 of that came in the form of grants. This figure is based on students attending both public and private colleges. Let's look at how the numbers differ between the two. At four-year public schools, eligible students received an average of $2,400 in grants, while at four-year private schools, that number more than tripled to $7,300. Unfortunately, the federal government is issuing more loans and fewer grants to students in need of aid. The available need-based grants are exhausted by students from lower-class families, leaving students from middle-class families—those making $25,000 to $75,000 annually—largely dependent on college loans.

Federal Work-study:

Work-study is a federally funded program. Students are provided with part-time employment and receive a paycheck that can be used toward books, supplies, and personal expenses. Not only does it help students with the financial burden of college, but it also gives them work experience while they serve the university or sometimes the surrounding community. Usually, students who receive a federally subsidized loan are required to participate in the work-study program by putting in 10 to 15 hours weekly.

How many college students fund education with loans, and what is their average loan debt?

To answer this question, consider these statistics:

According to the College Board, during the 2002-2003 school year alone, students across the U.S. borrowed $47.7 billion in federal college loans and an additional $7.5 billion in college loans from other sources.
According to Nellie Mae, one of the leading national providers of college loans, the average undergraduate student loan debt in April 2003 was $18,900.
According to a report from USA Today, in the year 2000, 26% of households under age 35 were burdened by student loan debt. They owed an average of $15,700, a 142% increase since 1991.
According to the Collegiate Funding Services, students completing a graduate or professional program have an average student loan debt of $23,000.
   What should you consider before deciding to get a loan?
   Before taking out a college loan, it is best to round up as much “free money” as possible. Also, think about whether the price tag of a private school is worth the extra cost, which often translates into long-term debt. Ask yourself if there are other ways to cut college expenses, such as living with your parents while attending to your hometown college. And consider part-time employment. Another helpful idea is avoiding debt altogether by making lifestyle changes. For example, choose to put off getting a cell phone or buying a car until you get a job. Sometimes you need to make lifestyle choices in order to make an investment such as education. Why should you give careful consideration before taking out a loan? The reason is clear: students who go into debt to fund their education experience a financial burden that students who graduate debt-free don't feel. Compound that with credit card debt, and it can be overwhelming. Only 59% of college graduates agree that the benefits of incurring student loans are worth it overall, indicating that this decision should be carefully considered.
   Students from lower-income households are much more likely to graduate from college with debt. In 1999-2000, 71% of students from households with annual incomes below $20,000 graduated with debt, compared to 44% of students from households making more than $100,000. More and more students with college loans feel burdened by their debt, and 25% of borrowers perceive themselves as having a significant problem. Of student borrowers who attended a public, four-year college, 39% said their debt levels were so unmanageable that they absorb more than 8% of their take-home pay once repayment began. In fact, medical bills and college debt are the main reasons that young Americans declare bankruptcy. One young man, about to launch a career as an orthopedic surgeon, amassed $400,000 in loans during 4 years of undergraduate school, 4 years of medical school, 1 year in an MBA program, and a 5-year residency. Interest payments alone are $20,000 a year
   What are the types of loans?

There are different types of loans available. We are going to break down these types into two main categories: loans based on financial need and loans that are not need-based.

Loans Based on Financial Need:

The federal government is the main source of funding for need-based loans. Need-based loans typically share three features. First, they have considerably low interest rates. Second, with the delayed repayment feature, no payments are required on the amount borrowed until after the student graduates or leaves school. Third, the government pays all of the interest that accrues on the loan while the student is in college and for a grace period after graduation, which is typically six months. After that grace period, borrowers must begin making payments and usually have 10 years to pay off the loan.

Federally guaranteed student loans are also typically variable rate loans, and some or all of the interest on these loans may be tax deductible. With terms like these, it's easy to see why these federal loans are certainly a better way to fund college than using a credit card, refinancing a home, or getting higher interest loans. The two primary need-based loans are Federal Subsidized Stafford Loans and Perkins Loans.
Federal Subsidized Stafford Loans
   Federal Subsidized Stafford Loans are borrowed in the student's name. The student's credit rating is not considered, so even if the student has no credit or bad credit, this is not a problem. Eligible undergraduate students can borrow increasing amounts in successive school years.

Federal Subsidized Stafford Loans can be made directly from the federal government, commonly referred to as a Direct Loan, or it can come from a private source such as a bank, credit union, or savings and loan. No matter the lender, Subsidized Stafford Loans offer a low, variable interest rate that is capped, meaning it will never go higher than a fixed rate. The Department of Education adjusts the interest rate each year on July 1. The rate is based on the 91-day Treasury Bill plus 1.7% while the student is in college, during the grace period, and during deferment periods, which we will discuss later. During the repayment period, the interest rate is based on the 91-day Treasury Bill plus 3.1% t.
Federal Perkins Loans

Federal Perkins Loans funds come from the government with a portion being contributed by the college. The government distributes these funds to colleges around the country, who then become the lenders for this type of loan. While not as common as the Federal Stafford Loan, the Perkins Loan is still very affordable. Another similarity is that it is borrowed in the student's name without consideration of his credit rating. Perkins Loans have an annual and cumulative limits. However, the actual amount an eligible student receives depends on his financial need, how early he applies, and the amount of funding the school receives.

Loans Not Based on Financial Need:

During the financial aid application process, the family's financial situation is assessed through a standardized process. A level of need is established along with a threshold for the family's expected contribution to funding the student's education. Sometimes, a family isn't able to pay as much as expected, but the household income is too high to qualify for need-based loans. For this reason, there are a number of loan programs available that do not depend on a student's financial need. Non-need-based loans share three characteristics. First, they usually have higher interest rates than need-based loans. Second, there is no in-school interest subsidy. This means that interest accrues while the student is in school, and this interest must be paid by the borrower, sometimes while the student is still attending college. Finally, non-need-based loans may require immediate repayment of the principal, so loan payments could actually be required while the student is in school. The main types of non-need-based loans are Federal Unsubsidized Stafford Loans, Federal PLUS Loans, and a wide variety of private loans.
Federal Unsubsidized Stafford Loans
   Federal Unsubsidized Stafford Loans differ from Federal Subsidized Loans in one key way. Unsubsidized means that the federal government does not pay for the interest that accrues while the student is in college. The borrower must either pay the interest while they attend school, making their post-graduate bill smaller, or they can defer making interest payments until graduation. The federal government is offering more unsubsidized loans and fewer subsidized loans. This ultimately means a larger debt for student borrowers.
Federal PLUS Loans
   The acronym “PLUS” stands for “Parent Loan for Undergraduate Students”. Unlike loans discussed previously, a PLUS loan is taken out in the parent's or guardian's name. Parents and guardians must meet federal minimum standards for credit worthiness to qualify for a loan. Fortunately, these standards are not as stringent as those for a mortgage. The amount that can be borrowed is calculated by figuring the cost of the dependent student's undergraduate education at his particular school and then subtracting the amount of additional aid that the student is awarded. For instance, if the annual cost of a student's education is $24,000 and she is receiving a $5,000 scholarship for the year but no other aid, her parents could borrow the remaining $19,000. Federal PLUS Loans have a variable interest rate capped at 9.0%. Every year the Department of Education adjusts the rate, which is based on the 91-day Treasury Bill plus 3.1%. Repayment must begin 60 days after funds are dispersed. In the past, students had to take out all of the Stafford Loans possible before parents could apply for a PLUS Loan. This is no longer the case. In fact, the student doesn't even have to take out a Stafford Loan. But since Stafford Loans offer lower interest rates and deferred interest, it would certainly be wise to consider Stafford Loans first.
Private Loans
   The average cost of a four-year private college education has increased by 43% since 1992 while federal loan limits have not increased in over a decade. Therefore, more students are turning to private lenders to help finance education. In fact, the total amount borrowed from private lenders for education purposed is now greater than the amount awarded through federal student education grants, the Work-study Program, and the Federal Perkins Loans programs combined. Although private lending certainly has increased, it still makes up only 10% of all student loans. Of the 4% of undergraduates who receive private loans, most attend schools with high tuitions or have a very pronounced financial need. Since private loans require a credit check, they are usually taken out in the parent or guardian's name. Creditworthy students may be eligible, but a cosigner may be needed. Private loans allow borrowing for expenses beyond tuition, such as room and board. In many instances, “emergency loans” in amounts up to $300 are also available.
   What should you look for when selecting the right college loan for you?
   When comparing loans, it's important that you compare terms so you get the best deal. Here are four key things to consider:
Interest Rate—The lower the interest rate, the less expensive the loan is and the less money the borrower has to pay back. Make sure you understand how the interest is calculated, as well. The more often interest is calculated, the larger the debt becomes.
Subsidized vs. Unsubsidized—A subsidized loan is preferable over an unsubsidized loan because the government foots the bill for the interest that accrues while the student is in college. Those interest charges can add up.
Fees—Most loans have various fees, such as origination and processing fees. These fees tend to be higher with private lenders. Read the fine print so you know what to expect.
Repayment Plans—Repayment plans vary by lender and by individual loan. Sometimes there are incentives for consistently making payments on time. Also, if you may take out several loans over the course of schooling, make sure at least one lender has a good consolidation plan.

Based on the factors mentioned above, need-based federal student loans tend to be the best type of loan available. If you aren't eligible for a need-based federal student loan, your next best choice is likely the non-need-based federal student loans. Federal PLUS Loans tend to be better than loans from private lenders. However, some colleges have their own parent loan programs. To find out if your college has one and who is eligible, contact the financial aid office. This is certainly an option worth considering.

Finally, as you compare loans, only borrow what you need. Just because you are eligible for a certain size loan doesn't mean you need to take the full amount or take any of it for that matter. Even with the best loan available, you still will have to repay the debt with some amount of interest.

How do you apply for federal aid including loans?

Since the amount of financial aid is limited, it's best to begin apply for aid as soon as possible for the upcoming academic year. Once you begin apply to schools, check to see if they require you to complete the CSS Profile Application or any type of institutional aid application, especially if you are applying to a private university. This application is sometimes used to help determine financial need. These forms can sometimes be completed earlier than the FAFSA, which is the Free Application for Federal Student Aid. The FAFSA form must be submitted to be considered for federal grants, student loans, PLUS loans, and the Federal Work-study Program. It is used to evaluate the family's financial situation and qualify students for aid based on guidelines from the U.S. Department of Education. Although the actual government deadline for the form isn't until June 30 preceding the academic year for which aid is being sought, it's best to apply early. In fact, many colleges require that the FAFSA be submitted as early as the February prior to the academic year. Since the form requires you to supply quite a bit of detailed information, having your tax returns, pay stubs, and bank statements for the past year handy makes the task much easier. For this reason, many parents wait to fill out the FAFSA until they prepare their income tax return in April, but this is not a good idea. The sooner your FAFSA is processed, the more funds are still available for disbursement. The FAFSA can be completed online. Be sure to fill it out completely and indicate which college(s) should receive your information; otherwise, your form may be rejected, causing a significant delay. After receiving your FAFSA, the Department of Education will put together a Student Aid Report (SAR). Based on your particular financial situation, the SAR will include a dollar amount for your Expected Family Contribution (EFC). Within four to eight weeks, it will submit the SAR to the colleges you indicated. With the report in hand, the college's financial aid office will compare your EFC to the cost of tuition and associated fees at that particular school. This calculation helps prioritize which students will receive need-based aid. Private universities are especially sensitive to special situations and often have their own funds to help defray the cost of college for students from these families. However, sometimes these unique financial circumstances don't come across in the FAFSA. If you have a special situation in your family, such as a recent job loss, disability, or death in the family, consider sending a letter directly to the college's financial aid office after the necessary forms have been completed. After the college has determined what aid the student is eligible for, it will issue an award letter outlining the financial aid package and EFC. Depending on when you applied for aid, this letter will usually arrive in the spring or early summer. If you have applied for admission and for aid at more than one school, you will receive more than one letter. Every financial aid package is different, so compare them carefully while considering the particular schools' tuition and fee costs. After evaluating the award, let the college financial aid office know if you accept or decline the aid. You do not have to take the entire loan package. For instance, if you are eligible for both grants and loans, you don't have to accept the loan. For that matter, you can also accept less than the total loan amount. When it comes to loans, the more you take, the more debt burden you have. To determine if you really need a loan and, if so, how much money you need, add together all of your available funding, whether it's a scholarship, college savings your parents set aside, Work-study or summer job income, grants, etc. From that amount, subtract your projected education-related expenses: tuition, fees, textbooks, room and board, etc. If you are in the red, get a loan just large enough to cover that amount. One thing to keep in mind as you decide what parts of the aid offer you agree to: you may not be able to decline work-study and still receive some types of federal loans. If you find errors in the award letter, if your financial situation has changed, or if you think a special circumstance was overlooked, you can appeal to the financial aid office to reconsider your offer. It is a good idea to supply any documentation to support your claims.

While this is a touchy situation that must be handled with tact, you may also be able to use a better financial aid package from another school as leverage to improve an offer. Keep in mind that private schools have more room to negotiate than state colleges, and prestigious schools have a waiting list of applicants, so they are less willing to make concessions. If you decide to play the leverage game, be prepared to provide a copy of the other offer. Also, rather than taking an aggressive, “in your face” approach, it is better to “play dumb”. You might simply inquire to the financial aid officer, “I don't understand why this school offered $X and you only offered $Y. Can you explain that to me?” When loans are listed as part of the financial aid award package, there are still more applications to fill out. Quite often, a school will send loan applications with the award letter. The student must select a lender, either from the provided list of lenders or from private loans. Note that award letters generally do not indicate if the parent is eligible for a PLUS Loan. One important thing to remember is that this is an annual process. Every year, you must apply to be considered for aid for the upcoming school year. As your family's financial situation changes, so can your total aid package.

How should you budget your college loan money?

Budgeting is often an area where students lack experience, and it can often get them into trouble. When it comes to student loans, there is one very important principle to keep in mind. It is inherent in its name: a student loan should be used for student expenses only. By using student loans for expenses other than direct school-related items, you are only succeeding in getting yourself more deeply in debt.

What are some of the problems people face with paying back student loans, and what are the options available to them?

Sometimes students are too optimistic about what their financial future holds immediately after graduation. And sometimes, graduates have trouble paying their student loan bills. Why? What's the problem? Unfortunately, everyone doesn't start at the top. In fact, sometimes it can take awhile to land a good job or any job for that matter. Meanwhile, the loan payments are coming due. Also, with loans listed on credit reports, how will you be able to get a car or rent an apartment? Many students face these fears. Also, new professionals may be faced with start-up expenses associated with their jobs, and that can take a chunk out of a checkbook. So, what is a person to do? Unfortunately, when students are enrolled in school they concentrate on paying their tuition, but at graduation they begin to panic. Students worry about their payment obligations. A number of lenders allow borrowers to adjust their payment plans and defer payments. Yes, for those having difficulty making loan payments, there may be options, but they come with a price. Consider these various payment options, their characteristics, and what the total cost of the loan might be when using these various them.

Standard Repayment Plan

The standard repayment plan is basically repayment the way it was intended. Usually, a fixed monthly payment is made for a period of 10 years, and the payment amount is typically at least $50, depending on the size of the loan. This is the fastest and cheapest way to get a loan paid off other than paying it off early.

Graduated Repayment Plan

The graduated repayment plan is designed to help those who are in entry-level jobs and are working their way up. The monthly payment amount starts low and increases over time, usually every two years. Typically, the loan maintains its 10-year term. Despite this, the borrower ends up paying about 5% more than he would with a normal repayment schedule.

Income-contingent Repayment Plan

The income-contingent repayment plan is typically only used in extenuating circumstances by borrowers with extremely low-paying jobs. As with the graduated repayment plan, monthly payments start low and gradually increase. But in this case, the increase in the payments is not tied to a timeline. Rather, it's based on the borrower's salary increases. To calculate the exact amount of the payment, the government uses the borrower's adjusted gross income as reported on his federal tax return. Rather than taking 10 years to repay, the income-contingent repayment plan takes anywhere from 15 to 25 years. The longer the loan, the more it costs in interest.

Extended Repayment Plan

The extended repayment plan is similar to the standard plan in that the borrower makes fixed monthly payments of at least $50 per month. However, the term of the loan is extended to 12 to 30 years depending on the loan amount rather than the traditional 10 years. This option was introduced in 1965 when the federal government passed the Student Assistance Act. While this option lowers the monthly payments, the interest charges accumulate over a longer period. Once again, the borrower ends up owing much more than with the standard repayment plan. If you face a problem repaying your college loan, it is good to know that all guaranty agencies and the U.S. Department of Education will accept regular monthly payments that are both reasonable to the agency and affordable to you. To determine a payment amount that is agreeable to all parties involved, call the U.S. Department of Education at 1.800.621.3115 and speak with a customer service rep who can assist you.

Deferments and Forbearances

Some situations qualify borrowers for postponement or adjustment of loan payments. These borrowers can apply for a deferment or forbearance. A deferment is a period during which payments are not required on a loan. Reasons to qualify for deferment include returning to school at least half time, performing an internship or fellowship, and serving in the military, Peace Corp, or other public service program. A forbearance allows a borrower to temporarily stop loan payments because of financial hardships, such as those caused by unemployment or disability. All lenders are required to allow up to 24 months of hardship forbearance.

Loan Consolidation

When juggling multiple loan payments, consolidation is another option made possible by the Student Assistance Act. But in this case, it's an option that can potentially save the borrower thousands of dollars in interest charges. By consolidating student loans into a single loan, borrowers can lock in a fixed interest rate that is up to four % lower than the original loans' variable rate. The fixed interest rate is determined using a formula from the federal government to calculate a weighted average of all the original loans combined. Because interest rates have been historically low recently, consolidation is an especially attractive option, and borrowers are wise to “lock-in” these low rates. Be sure to check the current interest rate when consolidating a loan. The cap is 8.25%. Beyond better interest rates that mean a less expensive loan, there are several other possible benefits of consolidation. Of course, there is the convenience of only have one student loan payment each month, and often this payment is drastically lower. The borrower may also maintain the option to exercise deferment and forbearance if a fitting situation arises or to participate in some type of extended repayment plan. Finally, loan consolidation can help the borrower's credit source by replacing multiple lenders with a single lender.

Consolidation isn't always the right choice for every borrower. Before consolidating, consider the following:
A borrower doesn't have to be graduating to consolidate his existing loans. In fact, not only does consolidation lock in federal education loans at their current lower rate, but any federal education loans that the student takes out before graduation would also take advantage of that annual rate.
If a student borrower might be eligible for loan repayment assistance through the military or some other program after graduation, he should not consolidate his loans. Consolidation could actually take away the opportunity for this type of assistance.
Once loans are consolidated, repayment typically begins within 60 days, regardless of whether the borrower is still in school. Furthermore, consolidated loans do not come with a grace period. Therefore, many borrowers choose to wait until near the end of the six-month grace period on their original loans before consolidating.
Borrowers can only consolidate all of their loans once. If the interest rate lowers after consolidation, a borrower cannot typically take advantage of this new rate. The only exceptions are if the borrower either did not include one of his loans in the original consolidation or if he takes out additional education loans afterward.
While federal guidelines apply to loan consolidation, programs vary from lender to lender. The most reputable lender is the U.S. government, often offering the best deal. Shop around to see what is available.
Consolidation to a lower interest rate really only saves a borrower money if he maintains the standard 10-year repayment term. By extending the term, the borrower pays more interest over time.
Finally, there are no penalties for paying off a consolidated loan early.

Loan Repayment Assistance

As mentioned earlier, borrowers may be able to get help repaying their loans. One way this might be possible is by going to work for Uncle Sam. The armed forces have great education benefits, and the Army, Navy, Air Force, Marine Corps, and Coast Guard all have a loan payback program for individuals who enlist after college. While the Army pays back up to $65,000 worth of loans over a three-year period, most branches pay back the loans over the course of enlistment. In addition to paying off those loans, joining the armed forces can open the doors to new career opportunities, provide training in a military specialty, and fund higher education. Thanks to the GI Bill, Uncle Sam can help pay for a graduate degree.

If you're not cut out for the military, there are a number of government programs to help borrowers pay back loans by serving their community and fellow man. Let's examine a few of those options.

The Peace Corps helps struggling nations across the globe with improvements in farming, economics, and education. Individuals can sign up for what typically amounts to a two-year tour of duty with this organization. While the conditions can be rough, there are a number of rewards. Perkins Loans recipients receive 15% cancellation of their loan amount for each year of the first two years of service and 20% for the third and fourth year. For other federally guaranteed loans, enlistees can defer loan payments during the entire length of service. Another benefit is that after completing a tour of duty, individuals have advanced hiring status for one year for federal jobs. Americorps is the arm of the Peace Corps that focuses its efforts here in the United States, whether cleaning up the environment or helping at-risk youths. For enlisting, Americorps pays up to $7,400 in living stipends along with $4,725 in education awards after the individual successfully completes one year of service. The education funds can be applied to student loans.

Another program for repayment assistance targets teachers. Teacher shortages exist in the public schools for certain subject areas, in areas that serve low-income students, and in special education. To entice individuals to fill these gaps, several states like California and Illinois offering incentives such as loan payback and cancellation. In turn, the teacher is typically expected to work four to five years in the underserved area. To find out more about this program, contact the recruiting office your state's education department.

What are the consequences of defaulting on a loan?

A loan is considered to be in default if the borrower fails to make payments on time, specifically if no effort at repayment has been made 365 days after the student graduates, leaves school, or falls below half-time enrollment status. The second highest default rate in the past decade occurred in 2003, with 5.4% of borrowers defaulting on their loans. The U.S. Department of Education attributes this to economic uncertainty, a diminishing job market, and rising tuition costs. Realize that borrowers just can't walk away from their obligation to repay a loan, at least not without some pretty significant consequences. Consider these ramifications:
Late fees are assessed on all late payments.
Late payments or defaults on loans can damage the borrower's credit rating. This bad information can stay on a credit report for seven years.
Once a loan is considered to be in default, the full payment becomes due immediately.
If a borrower allows a loan to go into default, he is no longer eligible for any type of deferment or forbearance, no matter what the circumstance.
Defaulted student loans have no statute of limitations for being enforced, which means the lender can continue to go after the borrower for as long as it takes to get repayment of the full amount owed. Importantly, School loans are almost immune to bankruptcy.
A number of tactics can be used to collect on a defaulted loan. First of all, the individual can be sued by the lender. If the lender or its collection agency concludes that the borrower refuses to pay the loan, the matter can be turned over to the Justice Department. From there, wages can be garnished and federal income tax refunds can be withheld. Also, the individual may become ineligible for other federal loans, like FHA and VA loans that are valuable when buying a home.
   If you face financial hardship, contact your lender immediately and work out some sort of payment arrangement rather than letting your loan default. Also, be sure that your lender always has your current contact information and is aware of whether you change or leave a school, graduate, change your enrollment status, join the armed forces or Peace Corps, etc.
   Are their any rewards for paying back a loan on time?
   Many lenders offer special incentives to good customers. For instance, some offer a ¼ of a percentage point interest rate deduction if the borrower allows the lender to automatically withdraw monthly loan payments from his bank account. The lender may also reward borrowers who consistently make their payments on time. For instance, borrowers who make on-time payments for 36 months may begin to enjoy a 2% interest rate drop.
   After graduating, is it better to pay off a college loan early or invest extra income?
   Do you have some extra cash that's burning a whole in your pocket? Before blowing it on an impulse purchase, consider applying it to an investment or paying off your student loan early. The question is, which of the two is the best choice: investing or early pay-off? To determine this, look at the interest rate you are being charged on your student loan(s). Now look at the interest rate you could earn through investments. If you can earn a higher interest rate than you are paying on your student loans, then it makes since to invest. For instance, if the interest rate on your student loan is 4%, but the mutual fund you are considering promises a return of 6%, investing in the mutual fund is a wise decision.
   If you do opt to pay off your debt rather than invest, pay off debts with the highest after-tax interest rates first. Write down all of your debts on paper along with their associated interest rate. If you have credit card debt, include these in the list. Begin by paying off the debts that are costing you the highest amount in interest.
   Credit Cards and College Students
   Understanding the Fine Print
   Credit card offers are everywhere. They are plastered across university bulletin boards, stuffed inside shopping bags at the campus bookstore checkout, and readily available by the register at nearby coffee shops and pizza parlors. Open your campus mailbox and you may find a collection of them. Head to the hottest spring break destination, and they will be waiting for you, ready to seduce you with some gimmick, whether it's a free shirt or hat, coffee mug or Frisbee, CD or video, or who knows what. Go to the mall to buy some jeans and get hit on again. “If you sign up today, you can save 10% off your purchase.” So do you fall for their lines? “Maybe just this once. After all, everybody's doing it!” Statistics show that, in fact, 83% of college students have at least one credit card, and undergrads carry an average of three cards. Actually, 55 percent of students acquire their first credit card during their freshman year, and do not even have a job. So why do so many credit card companies target college students with little to no income and often with growing student loan debt? According to the Nellie Mae, the student loan agency, students are actually a good credit risk. Research shows that student borrowers tend to stay loyal to their first credit card, using it to make purchase for years and years to come. Unfortunately, while young adults have frequently witnessed people whipping out their plastic to make a purchase, most don't learn the ins and outs of credit cards before taking the leap and make a commitment to one or more lenders. It is critical to be informed about what you are signing up for and to shop around for the best deal, not just the best gimmick. After all, all credit cards are not created equal, and what you don't know can cost you big time.
   In this segment, we will answer the following questions:
What is a credit card is and what are its primary functions for consumers?
How do credit card transactions work?
Who makes money off of credit cards and how?
What should you look for when selecting the right credit card for you?
   What is a credit card and what are its primary functions for consumers?
   A credit card is a form of debt. Unlike an ATM or debit card that draws from funds you have deposited in your bank account each time you make a transaction, a credit card draws from funds you don't have. That is to say that each time you use a credit card, you are borrowing money from the issuer. The lender pre-approves cardholders for a certain line of credit, also known as a credit limit. Credit cards are typically unsecured accounts. This means that the cardholder does not put up collateral assets that could be seized by the lender in the event that the debt is not paid. Credit cards serve two primary functions for the consumer. First, they serve as a means of making a payment for a purchase that is often more convenient than using cash or checks. This is especially true when the consumer is buying by phone or over the Internet. The merchant does not have to wait for your check to be mailed in and clear, and credit card information can be validated quickly and easily. This translates into speedy service for the customer. When ordering with a credit card, the merchandise can be shipped immediately. The second function of a credit card is to be a more convenient source of consumer credit than other types of loans. However, it can also be a more expensive alternative. Physically speaking, a credit card is a piece of plastic typically with a magnetic stripe of the back. The front of this card includes the cardholder's name, an account number, and an expiration date. The magnetic stripe contains encoded information about the credit account.
   How do credit card transactions work?
   To see what's involved in a credit card transaction, think about this scenario. Kelly is at the mall looking for a new outfit for her date this weekend with David. She finds just the thing, the cashier rings up the purchase, and oops! Kelly realizes that she doesn't have enough money in her checking account to cover a check. “Oh, but this outfit is hot. I have to have it!” she thinks. So Kelly whips out her plastic MBNA MasterCard. The clerk takes the card, swipes it through a computerized machine, and waits for the card to be approved. That's what Kelly sees, but what's going on that she can't see? When the card is swiped, the machine reads the account information contained on the magnetic stripe on the back of the card. The machine contacts MasterCard's computer system using a modem and telephone line. Why? MasterCard, Visa, and other such companies serve and are owned by the banks that issue their cards. MasterCard provides a central contact for merchants as they verify information on any MasterCard account, regardless of what bank or lender issued the card. In this scenario, MasterCard recognizes that Kelly's account was issued by MBNA, so it routes the transaction to MBNA's computer system. MBNA verifies that Kelly has an account with them, that her account is in good standing, and that her card has not been reported stolen. It also compares the transaction amount to her available credit. With that done, MBNA approves the transaction. At this point and just a matter of a few seconds later, the credit slip prints out at the cash register, Kelly signs it, and she's on her way. The transaction is not over. MasterCard must ensure that the funds are sent on Kelly's behalf from MBNA to the acquiring bank, which is the bank that holds the store's account. The transfer of funds may actually take a day or two. In the meantime, MBNA's computer system will indicate that Kelly has a charge pending and deducts this amount from her available credit. As mentioned, transactions don't always occur in person. More and more, consumers purchase things by phone or Internet. Let's look at how these transactions differ.
   While Kelly has been at the mall shopping, her date, David, figures he'll score a few points with her by ordering some flowers. He grabs his cell phone and calls one of those toll free numbers he's heard countless times on TV. “A dozen long stem roses cost how much?” Gulp! “Put it on my Visa.” David provides the operator with his full name as it appears on the card, the account number, and the expiration date. She enters it into her computer system, clicks on the “Process Order” button on her screen, and hears the modem on her computer begin to chirp. The account information and purchase amount are transmitted to Visa's computers. They recognize the account as being a Chase Visa card, so the transaction is routed to Chase's computer system. As with Kelly's purchase, the issuing bank goes through the verification process and approves the transaction. The operator sees that it was approved and provides David with an order verification number. Visa notes on David's account that he has a transaction pending. Within a couple of days, Visa will have made sure that Chase Bank transfers the funds for David's flower purchase into the florist's account with the acquiring bank.
   Who makes money from credit cards and how?
   Credit cards are big business, and more people are making money off of other people going into debt than you might think. For starters, there's the issuing bank. Again, that's the lending institution that actually extended the credit line—Chase, MBNA, Fleet, and CitiBank, just to name a few. These issuing banks charge the cardholder interest for carrying a credit card balance with them, that is to say for not paying off the full amount charged each month when the payment is due. They also charge a variety of fees for being over the credit limit, making a late payment, getting a cash advance, and other things. But those aren't the only ways that issuing banks make money. For every time the cardholder uses his plastic, the issuing bank charges an interchange fee to the acquiring bank, which is again the bank who “acquires” or collects money for the merchant from whom purchases are made. There's something in it for the acquiring bank, too. It charges the merchant a fee each time a credit card transaction is processed, usually amounting to about two percent of the total charged by the cardholder. So, for instance, if you use your credit card to purchase a pair of $100 boots, the merchant actually receives $98 of that, and the other $2 goes to the acquiring bank.
   Now you know how the issuing bank and acquiring banks make their money. What about Visa and MasterCard? These organizations charge membership dues and fees to the banks that issue cards under their name and use them as a hub for transaction processing. Guess who else may be getting a cut? Your school may be! Many universities charge the credit card companies and other solicitors fees, which could range for $75 to $350, for setting up a table on campus. To other schools, that income is pocket change. For instance, one university received $2.3 million from a credit card company for an exclusive marketing agreement targeting both students and alumni. If you sport a credit card with your university logo, then you can bet your alma mater is in on the profits. Affinity cards allow cardholders to make a contribution to an organization each time they make a purchase. Many university groups such as alumni organizations are taking advantage of school spirit and reaping rewards that credit card companies offer them. Schools are cashing in, and the more the cardholders charge to their affinity cards, the more rebate money the university receives. Schools like these have a vested interest in signing up as many people for their affinity cards as possible. And credit card companies are always looking for a way to infiltrate the college campus, whether they are offering an affinity card or some other type of card. That is why it is not uncommon to see tables set up on campus signing students up to get their very own plastic.
   Notice who is sitting on the other side of the table handing out the applications. Often, credit card companies recruit your fellow students in campus organizations to man those tables, and they get paid for every application that is filled out. To make matters even worse, a lot of the cards offered on college campuses are not good values. A study found that students who get credit cards at these campus sign-up events have higher unpaid balances than those who obtain cards elsewhere. Fortunately, many schools are sitting up and taking notice, actually implementing codes of conduct for credit card solicitors on campus. For instance, the university may allow the company to set up a table on campus to hand out applications but prohibit it from collecting completed applications, or the company may be required to distribute credit education information. Others still are banning card solicitors on campus altogether.
   Do people don't really sign up for a card just for the free gift? According to a survey of 460 college students conducted by the State PIRGs, 80 percent of the students who signed up for a credit card at an on-campus table cited the free gift as a reason for applying.
   What should you look for when selecting the right credit card for you?
   The ideal credit card is not necessarily the one that comes with the coolest free gift for applying, nor is it always the one with the lowest interest rate. It could be plagued with hidden fees that can really add up. To find the ideal card, you have to do your homework and read all the terms hidden in the application's fine print and muddle through a sea of asterisks and footnotes. Once you sign the application, these terms become a binding contract between you and the credit card issuer, also known as a “cardmember agreement.”
   In this segment, we will examine the most common terms for credit cards including:
Interest rates or finance charges
Grace period
Credit limits
Minimum payment
Fees
   Annual fees
   Cash advance fees
   Over limit fees
   Late fees
   Balance transfer fees
   Credit insurance fees
      Interest Rates or Finance Charges:
      Interest rates, which are commonly referred to as “finance charges” on credit card statements, are perhaps the most scrutinized factor when shopping for a credit card. It's important to know how the interest on any card you're considering is calculated. Interest rate has been defined as the rate at which a credit card company or other lender charges a customer for ‘borrowing’ money. It is a percentage of the amount borrowed. “APR” is a term you may have heard before, and it stands for “Annual Percentage Rate.” Creditors specify the annual interest rate for the purpose of determining how much interest a cardholder will be charged each billing cycle for his purchase balance. For instance, if a credit card carries a 12% APR, the cardholder is charged a monthly interest rate of 1%. If a credit card has a 24% APR, the cardholder is charged a monthly rate of 2%. There are two types of APRs: variable rate and fixed rate. Usually, a variable rated is based on the Prime Rate, which is set by the U.S. government, but it may also be based on the London Interbank Offered Rate (LIBOR). The Prime Rate and LIBOR fluctuate quarterly according to current economic index changes. Credit card companies charging a variable rate use the Prime Rate or LIBOR as a base and then add an additional percentage as determined by the individual company. This additional percentage is commonly called the “margin” or “spread”. A fixed rate is not based on any market index. Don't be misled into thinking the rate may never change. It can change at any time as long as the credit card company gives the cardholder at least 15 days notice. One way that credit card companies attract applicants is with special introductory rates. These are lower than normal APRs provided by the company for a limited period of time. For example, you may get an offer in the mail that reads, “No interest until May!” The important thing to remember is that these low rates do eventually go up, often in as soon as three to six months. The new interest rate may be as much as 20% or more. In fact, students typically are required to pay higher interest rates in the neighborhood of 18% to 20%. To make matters even worse, credit card companies also commonly include a clause in the fine print that allows for a penalty rate if the cardholder does not follow all the terms of the cardholder agreement. That means if you are even one day late with a payment, exceed the credit limit ever so slightly, or violate the terms in some other way, you could go from zero to 26 APR in 60 seconds. In fact, some agreements allow the issuer to impose a penalty rate if the cardholder is late making a payment to another creditor even if all the terms for its card are met. This is a trap student applicants commonly fall into; they are signing on for large debts with low initial interest rates that can skyrocket ultimately.
      Grace Period:
      Another thing to look for in the fine print is information on the credit card's grace period. This is the amount of time you have after making a new purchase with your credit card when you can pay off the debt without incurring an interest charge. It's that span of time between the transaction date and the billing date, and this can vary by company. Grace periods usually only apply to individuals who pay off their card balance in full each month. For those who carry or “roll over” a balance from month to month, interest may be charged as early as the day of the purchase, or it may not start for a few days when your credit card company pays into the merchant's account at the acquiring bank on your behalf.
      Credit Limits:
      Some people act as though they just won the lottery when they open up their mailbox and see an envelope with bold type that says, “You have been pre-approved for a credit line up to $50,000.” They need to back up and read it again, paying attention to those words “pre-approved” and “up to.” It may say “pre-approved”, but every applicant still must pass a credit check. By signing the application, the consumer authorizes the credit card company to review his credit report. Only after careful review will the company determine how much credit, if any, to extend to the applicant. Also, consumers need to realize that whatever they charge now, they will pay for sooner or later. Credit card companies usually extend credit lines between $500 and $3000 to college students; unfortunately, they also create a hole that students have trouble getting out of by raising the limit once the card is maxed out. The creditors get people hooked and then keep pushing more. One way to lessen the temptation to charge too much is by requesting a lower limit than what the card issuer extends. Just because you are approved for $3000 doesn't mean you have to keep that credit limit. Simply call the credit card company and ask that your limit be lowered to an amount you can easily pay off.
      Minimum Payment:
      Another thing to consider is how the credit card company sets the minimum payment. At the conclusion of every billing cycle, which is usually monthly, the company sends out billing statements. Every statement includes an amount for the minimum payment required. This is basically the smallest amount that the cardholder must pay toward the overall balance to keep the account in good standing. The minimum payment is often two percent of the outstanding balance. At this rate, if your balance is $2000, you would only be required to pay $20 a month. That sounds pretty good until you consider how much interest you would be paying on that debt in the long run. The more time you take to pay a debt, the more interest you pay. You might consider choosing a card that requires a greater minimum payment each cycle. Even better, pay off the balance monthly.
      Fees:
      Besides interest, credit card companies make money off cardholders by charging them fees for any number of things. It is essential to be familiar with these fees, which are outlined in the fine print of the credit card application and cardholder agreement.

Annual Fees

Some credit card companies charge a yearly fee. The fee can be $50 or even more. Some companies waive the annual fee for the first year, and still others charge no annual fee for the life of the card. Before you rush to the conclusion that you should look for a card without this fee, consider this piece of advice. It may be cheaper to pay an annual fee if the interest rate on your card is low enough. To decide, you need to calculate which is cheaper: a fee-based card with a low interest rate, or a no-fee card with a high interest rate. If you pay your balances in full every month, you pay no interest. If you are thrifty enough to have no monthly balances, the no-fee card is clearly the better deal. Individuals who carry a high balance from month to month are often better off with a card that charges an annual fee but offers a lower interest rate.

Cash Advance Fees

Most credit card companies today allow cardholders to do more than use their credit card accounts to make purchases with merchants. Cardholders can actually use them to get cash. Just present your credit card at a bank, pop the card into an ATM and enter you PIN, or write a convenience check provided by the credit card company, and voila! Cash in hand. This convenience comes with a price. For these transactions, credit card companies typically charge cash advance transaction fees, and these can be as high as five percent of the amount received. Interest on these transaction almost always begins accumulating immediately, and sometimes cardholders are charged a higher interest rate than for typical charges with merchants.^{T}

Over Limit Fees

Credit card companies give each cardholder a set credit limit, and they also have the ability to deny a charge if it puts the account over the limit. Rather than do this, they often go ahead and approve the transaction if it's within a certain amount over the limit. But they don't do this out of generosity. They turn around and slap an over limit fee on the account. This fee is often anywhere from $25 to $35. It's another way credit card companies make money. Sometimes it's not new charges that can put a cardholder over the limit. Instead, it's those ever-accumulating interest fees. Consumers near their credit limits should be aware that finance charges added to the account after the close of the current billing cycle can cause an over-limit status, even if the minimum payment has already been posted.

Late Fees

Professors aren't the only ones who don't like students to be late. Credit card companies punish cardholders if their payment is not received by the specified due date. One way they teach people a lesson is with a late fee. The amount of the late fee varies by company. Some charge two percent of the outstanding balance, and others have a flat fee that's as much as $35 regardless of the balance. This isn't the only punishment a tardy cardholder receives however. Many cardholder agreements allow the credit card issuer to raise the APR if the cardholder is late with even just one payment. Also, credit card companies report late payments to credit reporting agencies, which can damage the person's credit score significantly. Consider this safeguard. A number of banks issuing credit cards to students or consumers with no or bad credit require them to set up a savings account and maintain several hundred dollars in it. In the event that the cardholder is late with a payment, the bank will draw funds from the deposit account to resolve the delinquency. This is commonly referred to as a “secured” credit card.

Balance Transfer Fees

One thing to keep in mind is that credit card companies want to make money off you. They want you to charge and they want you to carry over your balance from month to month so you keep paying them interest fees. One way they encourage cardholders to load up accounts is by promoting balance transfers. A balance transfer occurs when a person takes an unpaid balance from one credit card account and moves it to another account. This can be a good idea in some instances. Consider this scenario. David decides to buy Kelly an engagement ring, but he has no cash. The jewelry store tells him that he can get a store credit card and there won't be any interest for six months. David figures that sounds pretty good. Maybe he can get a good job to pay off the card this summer. Well, David blows out his knee in May playing intramurals, and that means surgery, recuperation, and no job. The six months are up and boom! The interest rate on his jewelry store card leaps to 26 percent. That hurts the wallet! David gets to thinking that he has a Visa account with an APR of 18, which is a heck of a lot better than 26. His Visa balance is pretty low, and there's plenty of room to transfer the amount he owes the jewelry card over to his Visa. Before David transfers the funds, he needs to find out if his Visa card charges a balance transfer fee, which is often 2%-3% of the amount transferred. If so, he needs to calculate whether moving the debt from one card to another still makes good sense financially. Many credit card companies offer special promotions from time to time waiving balance transfer fees.

Credit Insurance Fees

Be sure to read the fine print or you may sign up for something you really don't want or need. One such thing is credit insurance, also known as a “payment protection plan”. While it's a good idea for some people, it doesn't make sense for everyone. Credit insurance gives an individual protection in the event that he can't make his credit card payment due to a specified event. Depending on the type of credit insurance, this event could be that the cardholder has become disabled, the cardholder has lost his job involuntarily by being laid off or fired, or the cardholder dies. Credit insurance guarantees that the minimum monthly payment will be made by the insurer following the event so the cardholder's account will remain in good standing. Credit insurance usually costs around 75 cents for each $100 of debt. This can quickly add up to a significant charge.

When shopping for the best credit card, there's one more thing to look for in the fine print, and it is one giant loophole. Most credit card offers include a clause that says if the applicant does not qualify for the card described in the offer, he will receive a lower grade card. Such a card usually has a higher APR and fees, but most offers don't disclose any specifics about the terms of these alternate cards. Beware of this bait and switch tactic.

So, what are some of the characteristics of a responsible cardholder?

A responsible cardholder has a manageable number of cards.

Multiple cards not only look bad on the credit reports, they also provide a greater window of spending opportunity. Students with multiple cards can fall more quickly into debt problems. Limit yourself to one card.

A responsible cardholder makes a wise choice of cards.

Shop around for the best interest rates and terms. A responsible cardholder pays off balances monthly. Most credit cards offer a grace period when no finance charges accrue, but this is typically only available to cardholders who pay off their balance in full each month. Paying off recent charges during the grace period can save a cardholder a significant amount of money in interest charges.

A responsible cardholder keeps the credit limit low.

Credit card issuers commonly raise a person's credit limit to entice him to spend more. The fact of the matter is, a cardholder can reject limit increases and request the limit to be kept low. Not only does this keep the debt level manageable, but it also helps cardholders avoid temptations with big financial consequences.

A responsible cardholder maintains an appropriate income-to-debt ratio.

People who have good financial sense maintain a manageable debt level. They know what they can afford, and they have a budget. These people don't make a purchase on a credit card that they can't afford to make in cash unless it is an absolute emergency. So, what is an appropriate income-to-debt ratio? Financial experts recommend that a person should spend no more than 20% of his net income (income after taxes) on short-term credit purchases like those made with credit cards. A mortgage is considered to be secured long-term debt and, therefore, is not included in this 20 percent. By owing less than 20% a person has even more flexibility and opportunity in his spending and investments. For people who rely on commission or tip income, which could fluctuate, or for those who are in an unsteady job, it's a good idea to keep their personal debt level even lower. Five percent of the annual income may be a better threshold. In these cases, many wise cardholders reserve their credit card use for emergencies only. Part of maintaining a manageable debt level also involves coming to grips with the difference between wants and needs. Believe it or not, cable TV and a cell phone are not needs. The wise consumer who has a limited incomes lives as frugally as possible on a day-to-day basis, indulging in an occasional luxury.

A responsible cardholder protects his credit card account information

Do not ever give out your credit card number to a solicitor. There are a number of scams out there, and cardholders must protect their credit card and account number just like they would their checkbook or a wallet with cash in it. Also be careful when using a credit card to shop online, and steer toward reputable vendors. Smart cardholders also know that one of the quickest ways to destroy a relationship is by letting someone else make purchases with their credit card. If you have ever watched a small claims court show on TV, no doubt you have heard the horror stories. Before letting your friend use your card, remember this word of advice.

A responsible cardholder uses cards to establish good credit.

Finally, people with good financial sense know that credit cards can be a good way to establish a credit history with a good credit score. Young adulthood is when this pursuit typically begins. When a person has no credit history or a poor credit history, he can have trouble getting a car loan or mortgage without a co-signer. Lenders want to know how the person has handled credit in the past before deciding whether to extend or loan and what the terms should be. He may also have to pay larger deposits with utility companies when setting up a household, and there may be other hassles. Credit cards are a good way of showing that you can assume debt and pay it off in a timely manner. But there is a certain irony about trying to get that first credit card: In the world of credit, if you have no credit history, you can't get a credit card. But you need a credit card in order to build a credit history. Considering that most college students are bombarded with credit card offers, you may think that getting a credit card is easy. The truth of the matter is that it is easy for college students to get plastic. Lenders perceive students to have bright futures, and therefore they are good credit risks. However, once those students leave school, if they don't already have a credit card or a good credit history, they often find that opportunities to get a card with good credit terms immediately decline. Since not having a credit history makes post-college life more complicated and more expensive, it is worth considering obtaining a credit card during your college years. It is usually easy to get one while you are a college student, regardless of whether you have a job or reliable source of income. Remember this very important point, though: If you decide to get a credit card to help you establish a credit history, you must use it wisely. If you accumulate too much debt, pay your bills late, or skip payments altogether, you still establish a credit history, but in this case it's a bad one.

Before we move on, realize that credit cards are not the only way to establish a credit history. Other ways include paying rent and other bills on time, maintaining a bank account, keeping a steady job, and repaying student loans according to schedule.

A responsible cardholder avoids the temptation to overspend.

Credit smart students realize that having a credit card requires some responsibility, especially since it can bring with it the temptation to overspend. Some individuals who are concerned about those temptations but still want to establish credit seek out cards where they are not as likely to run up a large debt with a shopping spree. A gasoline card is a good example since they are primarily used for gas purchases and perhaps a soft drink and a candy bar. As long as the cardholders pays off the debt monthly, it's unlikely that they will accumulate much of a debt.

What are some behaviors of someone who is on a dangerous path with his credit card use? Having examined good behaviors associated with credit cards, let's turn the tables and look at some behaviors that can lead to financial disaster.

A cardholder behaving recklessly may live beyond his means.

This behavior is at the core of a large percentage of credit card disasters. It can set off a domino effect, bringing out other irresponsible behaviors that we will examine momentarily. In today's society, the practice of living beyond one's means is not unusual. Movies, TV shows, and advertising only reinforce the idea that young people are entitled to have an affluent lifestyle. Only fueling the fire is an unhealthy attitude about debt. Like no other generation, today's 18- to 35-year-olds have grown up with a culture of debt—a product of easy credit, a booming economy, and expensive lifestyles. They often live paycheck to paycheck and use credit cards and loans to finance restaurant meals, high-tech toys, and new cars that they couldn't otherwise afford.

What else do young Americans put on their credit cards? Spring break trips, engagement rings, lavish weddings, extravagant honeymoons, airline tickets home for the holidays, Christmas gifts that they can't afford to give, computers, electronics, clothes, clothes, and more clothes. And when paying by credit card, it's more likely that consumers will purchase a better model than what they need or buy the expensive designer brand. Even the small charges for CDs, pizza, and beer add up. Many Americans “overextend themselves”, which is the politically correct way of saying that they incur too much debt for their level of income. People often don't realize the destruction of buying now and paying later until their required monthly credit card payments take a huge chunk out of their paycheck, which brings up an important point. Credit cards don't pay for anything; cash does. Credit cards only postpone the inevitable—sooner or later the consumer is going to have to fork over the cash for that CD or pair of boots or that new set of tires, plus interest. “Interest? What interest? I'm going to pay off my credit card when I get the bill.” Great! But be realistic. If you can't afford to pay cash for that big-screen TV that you're thinking about charging today, chances are you won't be able to afford it in a month when the bill arrives.

So how do unemployed or barely employed students pay off these exorbitant credit card purchases? Well, a number count on money from their parents or student loans—funds intended for education expenses. Some figure they can just pay the minimum until they graduate and strike it rich, assuming that a great job will be waiting for them. This may not be the case. The solution to growing debt may be a part-time job now. Although some students may think they don't have time for a job and school both, improved time management may resolve that issue. It just takes some planning. Speaking of planning, if you don't have a budget, it's time to make one. Our step-by-step guide simplifies the process. In the end, you will have a valuable tool to help you manage your money wisely and live within your means.

A cardholder behaving recklessly may “max out” his credit card.

When a person uses every bit of available credit on an account and pushes the limit, the card is considered to be “maxed out.” Not only does this leave no room on the card for emergency purchases, but it also has other ramification. If the card balance goes over the limit by as little as a dollar, the lender can charge over-limit fees. The cardholder must realize that once interest is charged on the account, that could put him over the limit. Once a person maxes out a card, a common temptation is just to go out and apply for another. This brings us to our next dangerous behavior.

A cardholder behaving recklessly may have too many cards to manage.

Having too many credit cards can be dangerous. In fact, some financial experts contend that if you even think you need another card, that it's a red flag to a credit problem. One card is enough, according to many experts, and the only thing that can come of another card is more credit problems. While we discussed gas cards and a retail store card earlier, some financial advisers suggest having only one major credit card, such as Visa, MasterCard, Discover, or American Express. By steering clear of gas cards and retail store cards, you avoid the high interest rates that they typically carry. Besides that, most gas stations and retail stores will accept a major credit card. You may think that restricting yourself to just one credit card is overly cautious. In reality, this helps you discipline yourself not to overspend. People who juggle multiple cards have to keep up with multiple bills. And while individually the interest charges on each account may be just a few bucks, add it all up and it can put a big dent in the checkbook.

A cardholder behaving recklessly may make impulse purchases.

Have you ever gone to a discount store to buy something in particular, and then been left waiting in line at the cash register? Have you ever glanced over the items on nearby shelves, racks, and refrigerators? You know—the magazines, candy bars, soft drinks, batteries, etc. These are called impulse items, and stores put them right in your path hoping that something will catch your eye and increase your spending. When consumers act on an impulse, they don't give the purchase much forethought. They typically don't compare prices and quality to make sure they are getting a good product at a good value. For instance, Mark just passed by four gas stations in search of the one with the best price. Then, after filling up, he went inside and grabbed a cold bottled drink before heading to the cashier. Mark could buy a two-litter bottle at the grocery store for the same price as he paid for this individual-sized soft drink, but he gave no thought to that. Gas stations make a lot of money charging consumers for convenience. Impulse purchases go beyond sodas and magazines, though. As mentioned earlier, people often buy a better model than they need or a designer brand when they make impulse purchases on a credit card. It can get out of control fast. So, why do consumers buy things that they really don't need? A number of people actually feel like they are unable to control their spending and actually use shopping as an escape, somewhat like an alcoholic does with a drink. In a survey, 40.4% of people report experience a mood swing, either high or low, just before or after shopping. The survey results also showed that 16.3% of respondents spend money as a way of escaping problems or relieving stress” and 17.1% say they feel alone or empty inside and use money to purchase goods or services in an attempt to feel better or improve their self-esteem. Developing a pattern of going on shopping sprees or taking a night out on the town at some expensive restaurant to blow off steam, escape boredom, or get out of a depressive funk can only lead to more problems. Another reason people make many impulse purchases is due to the influence of their friends. In the same survey, 6.8% of respondents said they felt the need to spend money on or with others in order to maintain a relationship with those people. Of course, sometimes this feeling to buy doesn't come from external peer pressure but rather from an inward lack of self-confidence. Some people buy things just to impress or influence others; 6.7% according to the survey.

A cardholder behaving recklessly may let others use his credit card account.

Peer pressure leads to our next point. Letting others use your credit card can be disastrous. Not only might this lead to friends habitually asking for financial favors, but it could definitely place a strain on the relationship if they fail to pay you back.

A cardholder behaving recklessly may just make the minimum payment and roll over debt from month to month. The first time a cardholder fails to pay off his credit card balance at the end of the billing cycle, he is setting a bad precedent. This can lead to growing debt as interest charges add up. Approximately half of all college students do not pay their credit card balances in full each month. In fact, this statistic pretty accurately applies to all cardholders in America. Why? Many people become trapped by debt. When the bill arrives, the cardholders pay what they can afford. Often this is just the minimum amount required by the creditor. Some people have so much debt that they spend all of their available money to pay off credit cards. In turn, they are left with no cash for groceries, gas, etc., so they resorting to making more charges to cover the necessities. Rolling over a balance can create an endless cycle of debt. As mentioned repeatedly before, it is essential that consumers maintain a manageable level of debt so they aren't put in the situation where they make minimum payments and roll over debt. Paying more than the minimum will save you thousands of dollars over time.

Credit card agreements outline how the lender calculates the minimum monthly payment. Typically, it is about 2-3% of the total balance. So, what does that look like? Well, if Keith has a $2,500 balance on his card and the lender set the minimum payment at 2%, Keith will be expected to pay at least $50 this month. So, if Keith makes the minimum payment and doesn't make any new charges, when he gets his bill next month the balance will be $2,450. Right? Wrong! When cardholders roll over debt from month to month and only make the minimum payments, even if they retire their card, the balance doesn't shrink much. That's because only about 10% of a minimum monthly payment goes toward knocking down the principal, or the total amount of purchases on the account. A whopping 90% of the minimum payment is actually applied to interest charges. So, as for that $50 check that Keith sent, only $5 of it went to the principal, and the other $45 was sucked up by interest. It is important to consider the total cost of credit over the length of the loan, not just the monthly payment.

Let's look at some more scenarios to illustrate this. Brett went to Florida for spring break and some fun in the sun. For the most part, his trip was financed by his credit card, which carries a 15.9% interest rate. Brett charged a grand total of $1,000, and now he plans on just making the minimum monthly payment. At this rate, Brett will be paying off his spring break vacation for 15.5 years. And with interest, it will cost him a total of $2,329, or more than 2.3 times the original charges.

Okay, Brett's friend Josh also goes on the trip. Now, Josh's credit card has a higher interest rate at 19%. He also charged $1,000, and Josh decides he's going to pay a flat $20 a month until the card is paid off. At this rate, Josh will have to make 99 monthly payments totaling $2,720. Using credit will have cost Josh $1,196 dollars, or about twice the original purchase.

Rounding out the trip is Rick. He also charged $1000, and, like Josh, his interest rate is 19%. Rick decides he's just going to pay the minimum, whatever it happens to be. For his particular card, the minimum monthly payment is 2.5% of the total balance. By the time all is said and done, seven years will have past, and Rick will have paid $730 in interest.

Let's raise the stakes a little bit. Latoya and Derrick recently got married. Between the engagement ring and the honeymoon, Derrick racked up a balance of $5,000. With a 15% interest rate and a minimum monthly payment of 2% of the total account balance, can you imagine how long it will take to pay off this debt and how much it will end up costing? They will be paying on this card for 32 years, and interest alone will cost $7,789.

Yes, how much you pay on your debt each month has an incredible impact on how much interest you end up paying and how long you are burdened by the debt. Believe it or not, you could easily still be paying for that pizza you ate during finals or that spring break trip to Cancun when you are 30 or even 50 years old.

A cardholder behaving recklessly may not pay his bills or pays them late.

Even worse than rolling over a balance is making a late payment or even skipping payments altogether. Creditors are making a killing off of charging cardholders late fees for payments that are as little as one day late. Furthermore, many credit card agreements stipulate that if a cardholder is ever late with one payment, the creditor can raise the interest rate. To make matters even worse, creditors may specify that rates can go up if the borrower is late making a payment to another lender. When things really get out of control, consumers can get hit with late payments from multiple cards. It's not unusual for a person in financial trouble to owe more than $100 a month just in late fees alone.

A cardholder behaving recklessly may get cash advances.

Cash advances should be avoided because they come with a price: cash advance fees, higher interest rates, and no grace period. When getting an advance from an automatic teller machine (ATM), there is also a transaction fee charged by the owner of the ATM.

Many cardholders are not aware that the convenience checks they sometimes receive in the mail from the lender may also be treated the same was as cash advances. These checks come unsolicited accompanied by letters encouraging cardholders to use the checks to pay off other debts or make purchases. Using these checks almost inevitably leads consumers deeper into debt. It's always good to read the fine print.

A cardholder behaving recklessly may card “hop”.

One tactic that creditors use to get cardholders to fill up the available credit on their cards is to entice them with offers to transfer balances from higher interest credit cards over to their card. Often, they will extend a special low interest rate for these transfers, but sometimes these have time limits. Many borrowers today seek out these low-interest transfer offers and regularly move around their debts. This is a practice sometimes called “card hopping” or “card surfing”. Sometimes, transferring a balance can be advantageous. However, it should be done with caution. Always read the fine print and understand the terms of the offer, and keep track of when promotional rate periods expire.

A cardholder behaving recklessly may use one card to pay off another.

There is no doubt that taking a cash advance from one card and using it to pay the bill for another card is a sign of serious trouble.

We have already looked at how interest charges can add up over time and how high levels of debt can make it difficult to keep up with even minimum monthly payments. However, the impact debt can have on a person's life doesn't stop here. In this section, we are going to look at some other consequences of debt including:
Bankruptcy
Sacrificed education
Bad credit score
Employment difficulties
Difficulty getting credit at a good rate
Burdened relationships
Other hassles
Other lost opportunities
Emotional turmoil
   Bankruptcy
   In 1999, approximately 461,000 Americans under age 35 sought protection from creditors through declaring bankruptcy, according to Harvard Law School professor and researcher Elizabeth Warren. This figure is up from 380,000 in 1991. In 2001, more young adults filed for bankruptcy than graduated from college. What exactly is bankruptcy, though? It's the relief a person can get from his debts his they greatly outweigh his assets. There are two types of bankruptcy for consumers. Chapter 7 bankruptcy erases the debts, whereas Chapter 13 reduces the debt and spreads out payments over a longer period of time. If a person has any assets, bankruptcy may require him to sell them in order to pay off some of the debt. Bankruptcy is a very serious step and should only be considered as a last resort. When a person files bankruptcy, it remains a part of his credit report for 10 years, whereas other negative information is erased after seven years. We will discuss credit reports in more detail in just a moment. Too many people abuse bankruptcy as a magic wand to make their creditors go away. They make it appear as though their creditor is the bad guy, when really the person filing bankruptcy is the bad guy for abusing his credit, causing the creditors to write off all that money as a loss, then avoiding the responsibility to pay back the creditors by legally cheating them out of what's owed to them. As this suggests, people who file bankruptcy suffer a serious blow to their financial reputations. Not surprising, a major opponent of bankruptcy is the credit card industry. In the first half of 2000 alone, credit card lenders spent more than $6 million to promote bankruptcy restrictions and to defeat pro-consumer bankruptcy legislation. By fighting to make it harder for borrowers to file bankruptcy and to increase the amount of debt they are liable for, the credit card industry hopes to reduce its own debt losses and increase profits. Some economic experts fear that if these lenders succeed in reducing their own risks, they will become more vicious as predators that encourage high levels of debt for even the least creditworthy consumer.
   Sacrificed Education
   A number of college students become so entangled by debt that they see no other option but to drop out of school so they can work full time. A University of Indiana administrator once remarked, “We lose more students to credit card debt than to academic failure.” The same can be said about many colleges across the United States.
   Bad Credit Score
   Having a large amount of debt as well as making late payments or skipping payments can have a negative impact on a person's credit score. So what? Oh, and what exactly is a credit score anyway? A credit score, sometimes referred to as a credit rating, is a measurement of a person's credit worthiness based on his past behavior. It's a number that indicates what kind of financial reputation a person has. The primary purpose of the score is to help lenders determine if the individual is a good risk and if he is likely to repay his debts and do so on time. A person's credit score plays a huge part in determining if he will get approved for a home or car loan or a credit card. It also helps determine the amount and terms that will be extended to the borrower. In other words, a lousy credit score could mean a small loan with a lousy interest rate, which ultimately costs the consumer money. There are a few other reasons why a credit score might be evaluated, and we'll look at some those in just a moment.
   Now, let's take a closer look at credit scores and how they are determined. The score is based on information contained in the consumer's credit report. The report, which is continuously updated, contains the consumer's credit history. It lists any accounts opened in the person's name, past and present. These accounts not only include loans and credit cards, but also music, video, and book clubs; leases; utility company accounts; health club memberships. The credit report indicates the balance for each account, the credit limit, when the account was opened, if late payments were ever made, and the maximum balance ever owed. Lenders supply this information to at least one of the three credit reporting agencies: Equifax, Experian, and TransUnion. Each of these companies maintains its own database and compiles its own report, but information is regularly shared between these companies. Even though the information in each of the reports is close to the same, it is possible for a person to have three different credit scores; one from each company. For obvious reasons, if a person has never had an account of any sort, then there will be no credit report for that individual. Consequently, there is also no credit score. Having credit accounts and loans open over a period of time helps a person establish a credit score. The credit risk score model and software used most widely to translate data from a credit report into a numeric credit score was developed by Fair Isaac and Company. For that reason, the credit score is also commonly called the FICO score. FICO isn't the end-all number, but it is a quick fix, much in the way a GPA doesn't describe the whole student but carries enough weight to make you study harder. What are some specific things that affect a person's credit score?

Payment history

When a person pays his bills on time, it indicates he is a responsible borrower and, therefore, is likely to be a good credit risk.

Bankruptcies

As mentioned earlier, bankruptcy can be detrimental to a person's credit score, making it next to impossible to get new loans or credit cards.

Amount owed and available credit

Lenders like to know how much credit is extended to a person and how much of that credit has been used. Unused credit may be looked at as potential debt, and too much of it can damage the credit score. However, it is certainly much worse to have use all of the available credit and “max out” the accounts.

Requests for New Credit

If a person repeatedly tries to open new accounts within a short period of time, this is cause for alarm, therefore damaging the credit score. For this reason, never apply for a credit card you don't intend to use just so you can get a free gift or a one-time discount.

Types of Credit

There are a variety of types of debt. For instance, there are loans that require a person to put something up for collateral, and there are also unsecured loans, which are loans where no collateral is offered. There are credit cards accounts that require the balance to be paid off each month, and then there are credit cards where the balance can roll over. Ideally, a consumer should be able to demonstrate that he can handle different types of debt. This will raise his credit score.

The exact formula for determining the credit score is a closely guarded trade secret. However, it has been determined that approximately 35% is based on payment history and 30% on outstanding debt level. The other factors are weighed to make up the remaining 35%. How can a person go about finding out what their credit score is and what is on their credit report? While consumers have been able to access copies of their credit report for some time, it wasn't until recently that they have been able to find out what their credit scores are. Credit reporting agencies and lenders kept this information a secret until 2001, when Congress passed a law allowing consumers to access their score, as well.

As a consumer, you can order a copy of your credit report with your score online or by phone from any or all of the three credit reporting agencies.

Equifax
Experian
TransUnion
   It's a good idea to check your credit report at least once a year for errors. If you are planning to apply for a mortgage or a loan in the near future, it's a good idea to check all three reports and to order these reports a few months before you anticipate applying for a loan. That way, you allow enough time to dispute any errors that may show up on the reports. Why check all three reports if these reporting agencies share information? Well, they can differ somewhat, and mistakes that appear on one report may not appear on others. Lenders each have their preference of which credit reporting agency supplies them reports, so it's good to put safe that each agency has accurate information. It typically costs around $15 for each credit report. However, there are instances where you may qualify for a free credit report. These include:
If you have been denied or notified of an adverse action related to credit within the last 60 days based on information from that particular reporting agency.
If you were denied or notified of an adverse action related to employment, insurance, a government license, or other government-granted benefit within the last 60 days based on information from that particular reporting agency.
If you were denied a lease or required to pay a higher than normal deposit within the last 60 days based on information from that particular reporting agency.
If you're unemployed and plan to look for a job within 60 days.
If you're on welfare.
If you have reason to believe the information in your credit is inaccurate because of fraud.
If you are a resident of Colorado, Georgia, Maine, Maryland, New Jersey, or Virginia. (Residents of these states are entitled to one free credit report each year.)
Remember, when ordering your credit report, select the option to include the credit score.
   Employment Difficulties
   Believe it or not, debt can even make working more difficult in a number of ways. For one, in certain professions, it can make landing a job more difficult. Employers often require a credit check as part of the screening process when filling certain job vacancies. In fields like financial services, government, and management, the job applicant's credit report is almost like a second resume. The way employers look at it, if the applicant can't handle his personal finances, how can he be expected to effectively manage someone else's finances, whether a client's or the company's itself.
   There can be problems beyond landing a job. A number of employers assume that employees have personal credit cards that can be used and later reimbursed by the company for job-related expenses. This is especially true when an employee is sent on a business trip and has expenses for lodging, car rental or taxis, meals, etc. It can be very awkward for an employee to have to disclose that he doesn't have any available credit, a situation that could make the employer even more leery about handing over a company credit card. Also, employers typically frown on handing out cash up front for trips.
   Difficulty getting credit at a good rate
   High levels of debt or any cause for a poor credit score can make it more difficult to get a loan or another credit card, at least at a decent rate. How does a credit score impact applying for a mortgage, specifically? A good FICO score of 750+can mean your interest rate on a home loan will be four percentage points lower than someone with a 500 score. This can mean over $200,000 in saved interest on a house. How can a bad credit score affect the amount of interest you pay on a car? For loan applicants with bad credit, auto loan lenders may charge the consumer as much as $5000 more than a person with a good credit score. To disguise this extra interest and make the vehicle affordable, lenders may spread out the monthly payments over 60 or 72 months rather than a standard 36-month loan.
   Burdened Relationships
   Debt can place a strain on relationships in a variety of ways. There are countless stories of young people who had to move back home with their parents or impose on some other relative or friend so they could have time to get back on their feet. In many cases, these individuals have jobs, and they pay enough to cover rent and utilities. However, the income that should go toward a place of their own is eaten up by credit card and loan payments. Another unfortunate situation is when a young person brings debt into a new marriage. The area of finances is one of the top things couples argue about, and when one or both partners enter a marriage with the baggage of debt, it only makes matters worse.
   Other Hassles
   There are a variety of hassles that come with debt. Businesses shy away from consumers who they see as a significant financial risk. These individuals may have a hard time opening a checking account or renting a car. They may get quoted higher rates for automobile and other types of insurance. And, as mentioned earlier, they may be required to pay higher deposits for utilities, including cell phone service. Then, if the consumer is late on his bills, there is a barrage of calls and letters from persistent creditors and collection agencies, eager to get paid.
   Other Lost Opportunities
   People in debt often play the “If only . . . ” scenario. “If only I didn't have all these credit cards, I could buy a home . . . or go to graduate school . . . or invest more in my 401k . . . or travel . . . or . . . ” The list goes on and on. Debt kills many opportunities. For too many young people, their money is in a time warp. While they should be using their income to pay for current needs and plan for future expenses, much of their money is getting sucked up by past expenditures. At a time when they could be setting aside money for a down payment on a home, many young people are mortgaging their financial future. Instead of getting a head start on saving for retirement, they are spending years digging themselves out of debt. Imagine what would happen if instead of being burdened by credit card and loan payments amounting to $300 per month, the same amount of money was freed up for other things. Think about how graduating debt free from college could put you in a better position to attain your desired lifestyle and reach your goals.
   Emotional turmoil
   All of the stress, worry, relationship problems, collection agency notices, and unending bills can take their toll on an individual. Young people with high debt levels are prone to depression, and this has sometimes even escalated to suicide.

### Exemplary Questions Presented To Student

Budget

Part 1: Pre-college

What do I spend now, and where does it go?
Where am I particularly vulnerable with regard to finances?
(Kim: Where do I get my income?)
Activity: Fill out a spending worksheet every day for a month
   Part 2: College years
Where will money go? How will college spending differ from pre-college spending?
Which of my expenditures are discretionary?
What controls might be helpful to me?
Where will I get my income?
Activity: Gather data to calculate anticipated total “real cost” of college
   Part 3: The Big Picture
What can a budget tell me?
Why should I budget?
What makes a budget effective?
   Part 4: The gap
Dealing with time gap between when funds are available and cost of attendance?
How can I reduce costs?
How can I increase income?
Can working too much actually increase the total cost of college (cost of a five-year degree, compared to a three- or four-year degree)?

### User Interface and Functionality Requirements for the Debt Calculator

Project Overview

Introduction

As part of the learning experience, a debt calculator is provided that students can use to calculate their own debt and see a variety of charts that show the relationship of the debt to time and interest.

Basic User Interface

Fields

The user will enter the following basic information: Name; Age; Date

Then she will be able to enter the following information for 1 to 6 different debts: (a) Name of Debt/Credit Card Name; (b) Start Date for Debt; (c) Amount of Debt; (d) Minimum Payment (percent that credit card companies use to calculate the minimum payment that the cardholder/borrower is required to pay each month; (d) APR; and (e) Planned Monthly Payment

Buttons

In order to manage the information, there will be four buttons below the debts listed:
Remove Debt—This removes selected debt from debts listed. If no debt is selected, it will either be grayed out or notify user of need to select a debt to remove first.
Add Debt—This brings up a dialog box for adding a new debt or add a new line for debt information to be gathered. The cursor is placed in the first field for editing.
Edit—This brings up a dialog box for editing the debt information so that the user can edit debt relevant fields. The cursor will be placed in the first field for editing.
A pop-up menu will be displayed, allowing the user to select various charts. These are listed below in more detail.
   Text Information Displayed
   The following calculations are displayed at all time, regardless of charts are being viewed:
Principal—This is the total principal that will be paid on all debts given the current payment plan designated.
Interest—This is the total interest that will be paid on all debts given the current payment plan.
Year Debt Paid—This is the calendar year that the debt will be totally paid off.
Age Debt Paid—This is the age of the user at the time the debt will be totally paid off.
   Charts Displayed
   There are six different types of charts that highlight various types of information.

### 1) Overall Debt

Each debt is represented as a vertical bar across the bottom axis, as shown in FIG. 1.

### 2) Yearly Accumulative Debt

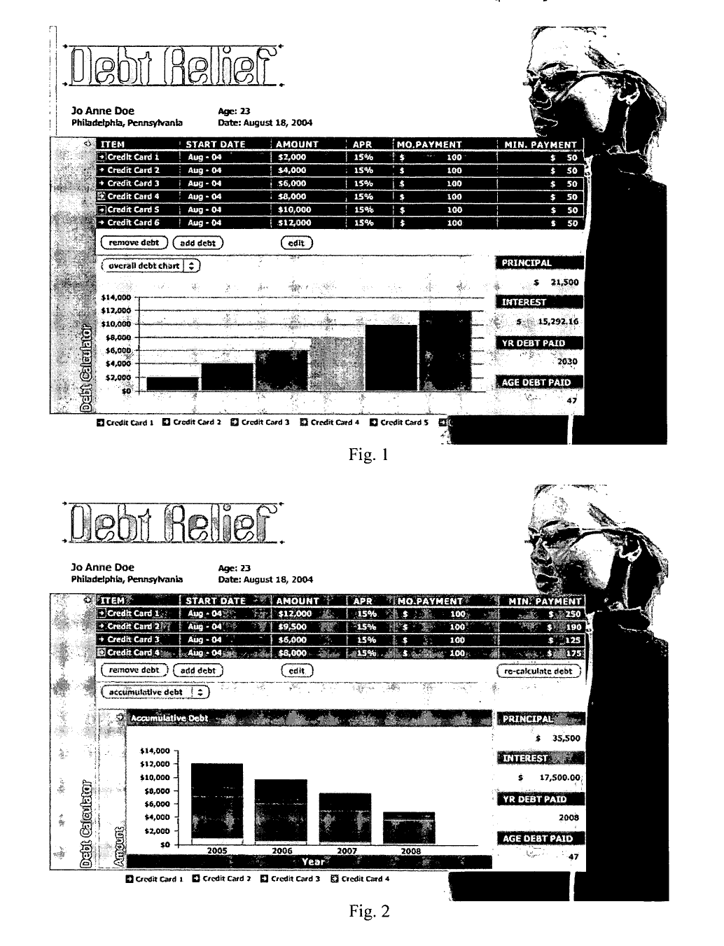

The debts are shown on FIG. 2 stacked on top of each other for each year.

### 3) Yearly Total Principal vs. Interest

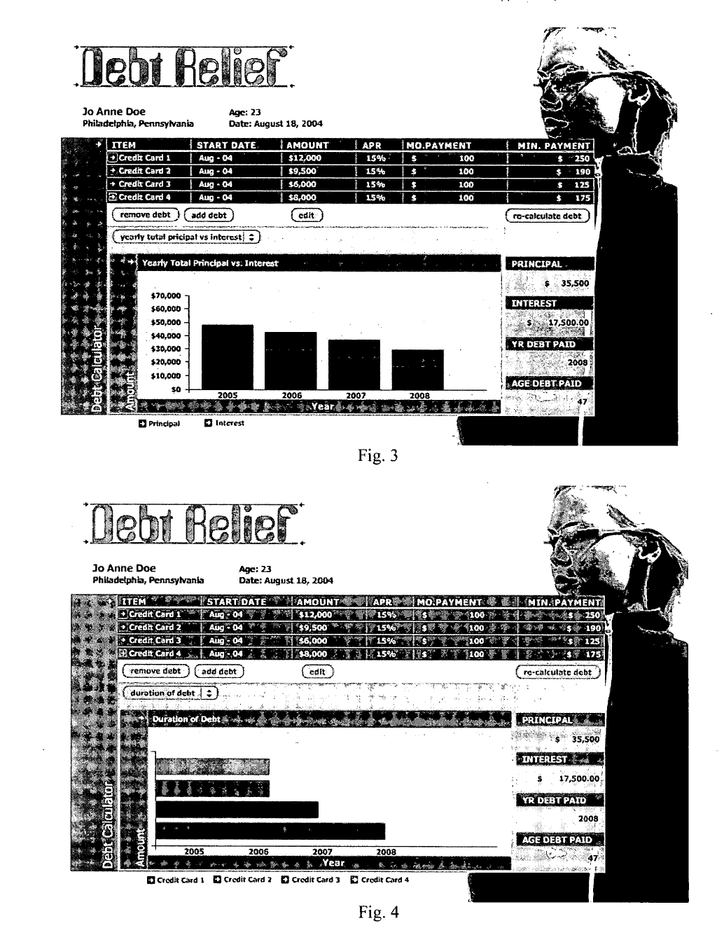

The debt in FIG. 3 is shown over the number of years it takes to pay off the debt divided by interest and principle each year.

### 4) Duration of Debt

FIG. 4 is similar to chart FIG. 1 in that each debt has its own bar, but the bar is showing the number of years until payoff instead of the total amount owed.

### 5) Principal vs. Interest by Debt

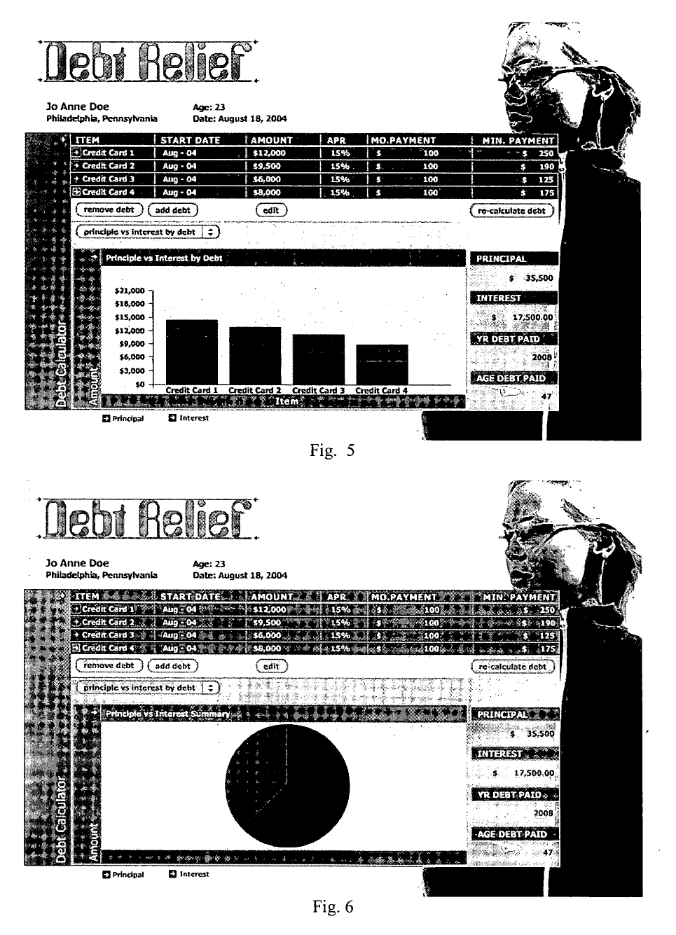

FIG. 5 shows each debt as its own bar, like FIG. 1. However, instead of showing just the amount owed, it shows the total amount that will be paid. The bottom portion being the principal (or what is owed) and the top portion showing the interest that will be paid.

### 6) Principal vs. Interest Summary

FIG. 6 is a simple pie chart showing total principal and interest for all debts over the entire life-span of the payment plan. The numbers for this chart are the same ones on constant display on the right side of the interface.

### 7) Layout

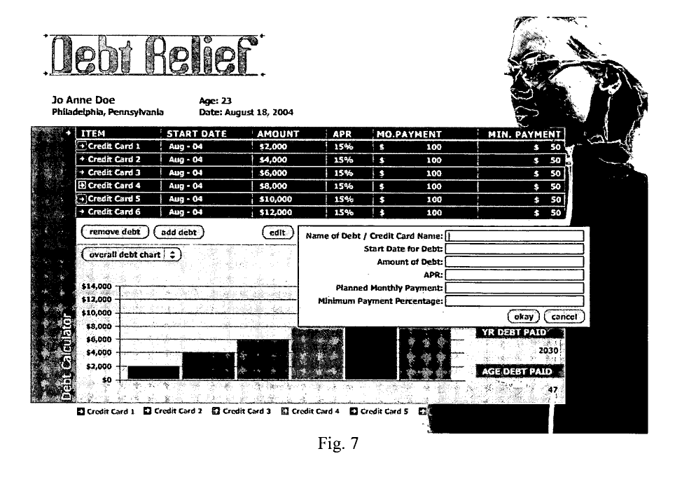

A layout of how this information is displayed is illustrated in FIG. 7.

Typical slides seen by the student, and with which they may interact on-line as part of the course, are as follows:

[image]

[image]

[image]

[image]

[image]

[image]

[image]

[image]

SLIDE 2—The Minimum Payment Mistake—Approximately half of college students do not pay their credit card balances in full each month. People become trapped by debt—

Pay what they can afford

Often the minimum amount required

Leads to growing debt as finance charges add up

Can be left with no cash for necessities

Leads to more charges

Creates an endless cycle of debt

Recommended income-to-debt ratio is ______%

SLIDE 3—This slide uses an example to show how much of the minimum payment actually goes toward paying off the principal.

Sample Questions For Student

Review Questions

1. Learning Objective 1.1

Common mistakes people make with credit cards include:

Select all that apply.
Having a “buy now, pay later” mentality (Correct Answer)
Getting more credit cards than manageable (Correct Answer)
Paying off their credit cards each month
Never using their credit cards
Rolling over a balance from one month to another (Correct Answer)
None of the above
   2. Learning Objective 1.1

According to financial advisers, individuals should carry ______ in credit card debt from month to month. Choose the best answer.
Less than $1000
Less than $100
$0 (Correct Answer)
No more than 5% of their annual income
No more than 5% of their monthly income
No more than 5% of the credit limit
   3. Learning Objective 1.1

Approximately half of all college students do not pay their credit card balances in full each month.

Choose the best answer.
True (Correct Answer)
False
   4. Learning Objective 1.2

The rate at which a credit card company or other lender charges a customer for borrowing money is known as the:

Choose the best answer.
Debt
Principal
CA—Interest rate
Finance charge
Roll over
   5. Learning Objective 1.2

Credit card companies normally set the minimum monthly payment at ______ of the total debt owed.

Choose the best answer.
2-3% (Correct Answer)
10%
15-18%
25%
45-50%
None of the above
   6. Learning Objective 1.2

Generally speaking, only about ______% of a minimum monthly payment goes toward paying off the principal.

Fill in the blank.
“10” or “ten” (Correct Answer)
   7. Learning Objective 1.2

Which of the following variables affect the total cost of credit?

Select all that apply.
Amount paid monthly (Correct Answer)
Principal (Correct Answer)
Interest rate (Correct Answer)
Credit limit
New credit card charges (Correct Answer)
None of the above

Having described preferred embodiments of new and improved on-line money management course, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

What is claimed is:

1. A computer-based, on-line, dynamically-delivered asynchronous, multimedia course, teaching financial fundamentals to teens and young adults.

2. The course of claim 1 wherein the course content is presented in the context of pre-college, college, and post-college life.

3. The course of claim 1 wherein the course content includes practical financial concepts, tools, and techniques that are relevant and useful to young adults.

4. The course of claim 3 wherein the course content is sub-divided into segments of said financial concepts, each segment being individually accessible by students at a web site controlled by a proprietor of the course.

5. The course of claim 4 wherein at least one of said segments pertains to debt management and another segment pertains to credit management.
